(19) United States
(12) Patent Application Publication
(10) Pub. No.: US 2003/0197475 A1
(43) Pub. Date: Oct. 23, 2003

(54) Flat-panel display, manufacturing method thereof, and portable terminal

(76) Inventors: Makoto Takamura, Kyoto-shi (JP); Hirotaka Nanno, Kyoto-shi (JP)

Correspondence Address: James V. Costigan, Esq., Hedman & Costigan, P.C., Suite 2003, 1185 Avenue of the Americas, New York, NY, 10036-2646, US

(21) Appl. No.: 10/405,137

(22) Filed: Apr. 2, 2003

(30) Foreign Application Priority Data
Apr. 4, 2002 (JP) JP2002-102600
Sep. 5, 2002 (JP) JP2002-133787
Sep. 5, 2002 (JP) 2002-133784

(51) Int. Cl. G09G 3/10

(52) U.S. Cl. 315/169.4

(57) ABSTRACT

A flat panel display which makes it possible to increase the proportion of the display occupied by the effective display region is constructed by arranging an input terminal portion on an outside surface or the periphery of the flat panel display, mounting an electronic circuit to an inside surface or an outside surface of a sealing cap, and forming wires on the inside surface or the outside surface of the sealing cap to connect the electronic circuit to an organic EL element and electrode terminals.

### BACKGROUND OF THE INVENTION

1. Field of the Invention

The present invention is related to a flat panel display such as a liquid crystal display device, a LED (Light Emitting Diode) display device, an organic EL (Electroluminescent) display device or an inorganic EL display device, a manufacturing method thereof, and a portable terminal equipped with this flat panel display. The flat panel display can also be used as a planar light emitting device.

2. Description of the Related Art

In the related art, a portable terminal, such as a portable telephone or PDA (Personal Digital Assistant) or the like, is equipped with a flat panel display. FIG. 1 is a schematic perspective drawing showing an organic EL display device as an example of a related art flat panel display. As shown in FIG. 1, a display device 101 is equipped with a substrate 102, a sealing cap 103 which faces the substrate 102, a plurality of display elements 4 which include a pair of electrode elements 41, 42 (i.e., a first electrode element 41 and a second electrode element 42), and drive ICs 51, 52 for driving the display elements 4, and an organic substance layer (omitted from the drawing) which includes a light emitting layer is provided between the pair of electrode elements 41, 42.

The substrate 102 is a transparent substrate. The substrate 102 includes an electrode arrangement region 121 in which anodes 41A and cathodes 42A (described later) are arranged, and a non-display region 129 which is a region that does not participate directly in the image display and which is provided adjacent to the electrode arrangement region 121. The sealing cap 103 is a component for protecting the display elements 4, and is connected to the top of the electrode arranging region 121 of the substrate 102 via a sealing member 107. Namely, the display device 101 is constructed so that the non-display region 129 of the substrate 102 protrudes toward the side of the sealing cap 103.

A plurality of strip-shaped anodes 41A and a plurality of strip-shaped cathodes 42A mutually orthogonal to each other are laminated onto the top of the substrate 102, and the intersecting regions thereof form the display elements 4. Namely, the first and second electrode elements 41, 42 are portions corresponding to each display element 4 at each anode 41A and each cathode 42A. The drive ICs 51, 52 conduct electricity to each anode 41A and each cathode 42A via wires 108A, 108B. When the drive ICs 51, 52 are operated to apply a prescribed voltage between the first electrode elements 41 and the second electrode elements 42 corresponding to selected display elements, electroluminescent light is emitted by the light emitting layer, and this light passes through the anode 41A and the substrate 102 and is emitted to the outside. In this way, an image is displayed by the light emitted by the selected display elements. In this regard, the effective display region in which the image is displayed is the region in which the display elements 4 are arranged, and in the electrode arrangement region 121, this forms a region which excludes the region in which the sealing member 107 is arranged. Namely, the effective display region in the substrate 102 forms a region which excludes the non-display region 129 and the region in which the sealing member 107 is arranged.

As shown in FIG. 1, the drive ICs 51, 52 are mounted directly on top of the non-display region 129, or are mounted on top of a flexible flat cable (FPC) 91 connected to the top of the non-display region 129. In other words, because the non-display region 129 is a region for connecting the drive ICs 51, 52 and the FPCs 91, 92, or a region for forming the wires 108A, 108B, a certain width is required. Accordingly, when the display device 101 is viewed flat, the proportion of the display device 101 occupied by the effective display region is small.

Further, the organic substance layer of the organic EL display device has the disadvantage of having a shortened life when water is absorbed. Consequently, because a drying agent is placed between the sealing cap 103 and the display elements 4 shown in FIG. 1, the display device 101 can not be made thin and ends up having a thick thickness.

Because the organic EL layer of the organic EL display device is weakened by water, the organic EL element is covered by a metallic sealing plate 65, as shown in FIG. 2, and this prevents water in the air from flowing in. Further, the organic EL layer is also weakened by heat, and because the organic EL layer is covered by the metallic sealing plate 65, when heat is applied, such heat causes irreversible damage to the organic EL layer. Consequently, because of the need for low temperature processing, bonding with an ultraviolet light hardening resin is carried out when the organic EL layer is covered by the sealing plate. In the organic EL display device shown in FIG. 2, an ultraviolet light hardening resin is applied to a glass substrate 66 of the organic EL element, and then after covering with the sealing plate 65, ultraviolet light is shone thereon. As shown in FIG. 2, in order to make it possible to shorten the hardening time, ultraviolet light 67 is shown from the transparent glass substrate 66 side to harden the ultraviolet light hardening resin. In accordance with this method, in order to prevent ultraviolet light from shining on the organic EL layer, it is necessary to carry out a process in which a mask large enough to cover the organic EL layer is placed on the surface of the glass substrate 66 before shining ultraviolet light thereon.

With the need for miniaturized portable telephones, there has been a need for enlargement of the display screen. An example of a portable telephone 101B equipped with the display device 101A described above is shown in FIG. 3. In FIG. 3, the effective display region of the display device 101A forms a display screen S₁₀₁. In the portable telephone 101B equipped with the display device 101A described above, because the proportion of the display device 101A occupied by the effective display region is small, there is a limit to the enlargement of the display device. In the portable telephone 101B, because a frame portion 110 having relatively large widths L_{A}, L_{B} is formed around the display screen S₁₀₁ formed by the effective display region in the display device 101A, the display screen S₁₀₁ becomes relatively narrow.

### SUMMARY OF THE INVENTION

In order to solve the problem of the related art described above, it is an object of the present invention to provide a flat panel display which makes it possible to enlarge the proportion of the flat panel display occupied by the effective display region, a method of manufacturing this flat panel display, and a portable terminal equipped with this flat panel display.

In order to achieve the objected stated above, the following technical means have been devised.

Namely, the flat panel display provided by the present invention includes a first plate-shaped member, a second plate-shaped member having at least one portion facing the first plate-shaped member, a plurality of display elements arranged in the shape of a matrix and including a pair of electrode elements, a drive IC for driving the plurality of display elements, and a plurality of wires which connect the drive IC to the display elements and which include an input terminal portion for applying a drive voltage to the display elements via the drive IC, wherein the first plate-shaped member and the second plate-shaped member have facing surfaces which face each other, non-facing surfaces which are opposite the facing surfaces, and a plurality of end surfaces which form a link between the facing surfaces and the non-facing surfaces, and wherein the input terminal portion is provided on one of the non-facing surfaces or one of the end surfaces.

For example, the input terminal portion is provided on at least one of the non-facing surfaces of the first and second plate-shaped members, and the drive IC is mounted to one of the non-facing surfaces of the first and second plate-shaped members.

In another example, the first plate-shaped member and the second plate-shaped member are bonded together via a sealing member, each wire includes a facing surface wire portion provided on the facing surface of the first plate-shaped member or second plate-shaped member on which the input terminal portion is formed, and at least one of the pair of electrode elements is electrically connected to the facing surface wire portions via the sealing member. As for the sealing member, it is possible to use an anisotropic conductive resin.

In another example, in order to connect the drive IC to the plurality of electrode elements, each wire further includes a non-facing surface wire portion which includes the input terminal portion provided on the non-facing surface of the first plate-shaped member or second plate-shaped member on which the input terminal portion is formed, and an end surface wire portion formed on one of the end surfaces of the first plate-shaped member or second plate-shaped member on which the input terminal portion is formed in order to form a connection between the non-facing surface wire portion and the facing surface wire portion.

Further, in another example, each wire further includes a non-facing surface wire portion which includes the input terminal portion provided on the non-facing surface of the first plate-shaped member or second plate-shaped member on which the input terminal portion is formed, and a through hole which forms a connection between the non-facing surface wire portion and the facing surface wire portion.

Further, the display elements include an organic substance layer provided between the pair of electrode elements, and the organic substance layer can be constructed to emit light by electroluminescence when a voltage is applied thereto using the pair of electrode elements.

The portable terminal according to the present invention is equipped with information display means for displaying specific information, wherein the above-described flat panel display according to the present invention is used as the information display means.

In another example, the flat panel display provided by the present invention includes a substrate, a plurality of display elements arranged in the shape of a matrix and including a pair of electrode elements, a drive IC for driving the plurality of display elements, and a plurality of wires which connect the drive IC to the display elements and which include an input terminal portion for applying a drive voltage to the display elements via the drive IC, wherein the substrate includes an active surface on which the plurality of display elements are arranged, a passive surface opposite the active surface, and a plurality of end surfaces which form a link between the active surface and the passive surface, and wherein the input terminal portion is provided on the passive surface or one of the end surfaces.

Further, the display elements include an organic substance layer provided between the pair of electrode elements, and the organic substance layer can be constructed to emit light by electroluminescence when a voltage is applied thereto using the pair of electrode elements.

Another example of a portable terminal according to the present invention is equipped with information display means for displaying specific information, wherein the above-described flat panel display according to the present invention is used as the information display means.

In another example, the flat panel display provided by the present invention includes a transparent substrate, a light emitting element which includes a plurality of display elements arranged in the shape of a matrix on top of the transparent substrate, a sealing plate which covers the light emitting element, an electronic circuit mounted to an inside surface of the sealing plate to operate the light emitting element, a plurality of electrode terminals arranged on the periphery of the light emitting element to form connections with outside wires, and a plurality of wires formed on the inside surface of the sealing plate to form connections between the light emitting element and the electronic circuit, and connections between the electrode terminals and the electronic circuit.

A drying agent layer can also be laminated onto the inside surface of the sealing plate.

Further, the sealing plate is bonded to the light emitting element by a seal which includes anisotropic conductive particles, whereby the electronic circuit is electrically connected to the display elements and the electrode elements.

Further, the electrode terminals are arranged only in one of the four directions of the light emitting element.

Further, the flat panel display described above can be constructed as an organic EL display device. In this case, the display elements include a transparent electrode layer, an organic EL layer and a metal electrode layer sequentially laminated onto the top of the transparent substrate.

Another example of a portable terminal according to the present invention is equipped with information display means for displaying specific information, wherein the above-described flat panel display according to the present invention is used as the information display means.

In another example, the flat panel display provided by the present invention includes a transparent substrate, a light emitting element which includes a plurality of display elements arranged in the shape of a matrix on top of the transparent substrate, a sealing plate made from crystallized glass which covers the light emitting element, an electronic circuit mounted to an outside surface of the sealing plate, a plurality of electrode terminals provided on the outside surface of the sealing plate, and a plurality of thick film wires which form connections between the electronic circuit and the electrode terminals.

Further, the sealing plate is bonded to the light emitting element by an ultraviolet light hardening resin.

Further, the flat panel display also includes a moisture absorbing agent housed in a concave portion formed in an inside surface of the sealing plate.

The flat panel display described above can be constructed as an organic EL display device. In this case, the display elements include a transparent electrode layer, an organic EL layer and a metal electrode layer sequentially laminated onto the top of the transparent substrate.

Another example of a portable terminal according to the present invention is equipped with information display means for displaying specific information, wherein the above-described flat panel display according to the present invention is used as the information display means.

The method of manufacturing a flat panel display according to the present invention includes the steps of bonding a sealing plate made of crystallized glass to a light emitting element having a plurality of display elements arranged in the shape of a matrix on top of a transparent substrate, mounting an electronic circuit to an outside surface of the sealing plate in advance, forming thick film wires on the outside surface of the sealing plate in advance, applying an ultraviolet light hardening resin between the sealing plate and an organic EL element, and hardening the ultraviolet light hardening resin by ultraviolet light shone from the sealing plate side.

In the method of manufacturing a flat panel display described above, it is possible to manufacture the flat panel display as an organic EL display device. In this case, the display elements include a transparent electrode layer, an organic EL layer and a metal electrode layer sequentially laminated onto the top of the transparent substrate.

Another example of a portable terminal according to the present invention is equipped with information display means for displaying specific information, wherein a flat panel display manufactured by the above-described method of manufacturing a flat panel display is used as the information display means.

### BRIEF DESCRIPTION OF THE DRAWINGS

FIG. 1 is a schematic perspective drawing showing an organic EL display device as one example of a related art flat panel display.

FIG. 2 is a schematic perspective drawing showing an organic EL display device as one example of a related art flat panel display.

FIG. 3 is a schematic perspective drawing showing a portable telephone as one example of a related art portable terminal.

FIG. 4 is a schematic perspective drawing showing an organic EL display device as one example of a flat panel display according to the present invention.

FIG. 5 is a schematic perspective drawing showing the internal structure of the organic EL display device of FIG. 4 in detail.

FIG. 6 is a cross-sectional drawing taken along the lines IV-IV of FIG. 4.

FIG. 7 is a schematic cross-sectional drawing showing another example of a flat panel display according to the present invention.

FIG. 8 is a schematic perspective drawing showing another example of a flat panel display according to the present invention.

FIG. 9 is a schematic perspective drawing showing another example of a flat panel display according to the present invention.

FIG. 10 is a schematic drawing showing another example of a flat panel display according to the present invention.

FIG. 11 is a cross-sectional drawing showing another example of a flat panel display according to the present invention.

FIG. 12 is a cross-sectional drawing showing another example of a flat panel display according to the present invention.

FIG. 13 is a schematic drawing showing another example of a flat panel display according to the present invention.

FIG. 14 is a cross-sectional drawing showing another example of a flat panel display according to the present invention.

FIG. 15 is a schematic drawing showing another example of a flat panel display according to the present invention.

FIG. 16 is a cross-sectional drawing showing another example of a flat panel display according to the present invention.

FIG. 17 is an outside view drawing showing a portable telephone as one example of a portable terminal according to the present invention.

FIG. 18 is a schematic perspective drawing showing a portable telephone as one example of a portable terminal according to the present invention.

### DETAILED DESCRIPTION OF THE PREFERRED EMBODIMENTS

The preferred embodiments of the present invention will now be described in detail with reference to the drawings.

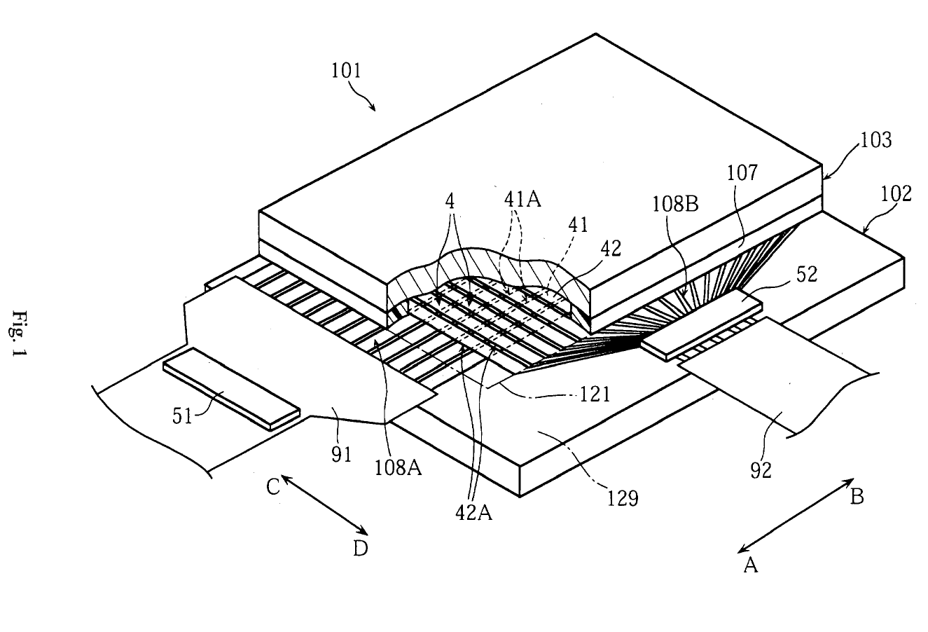

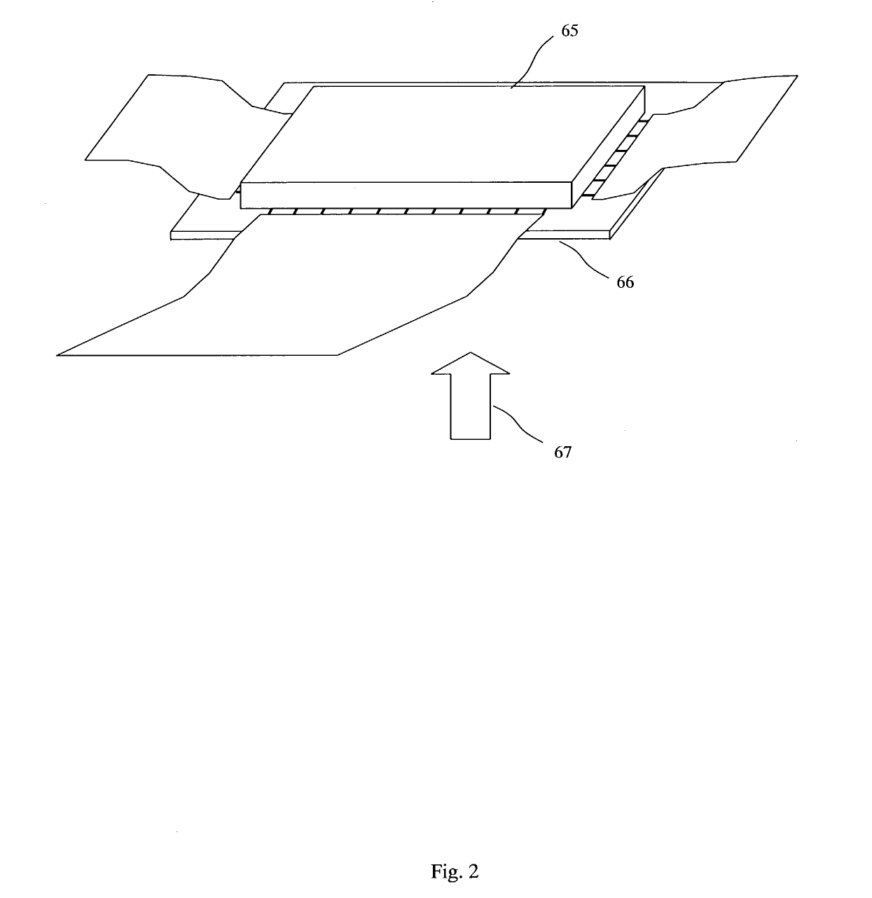

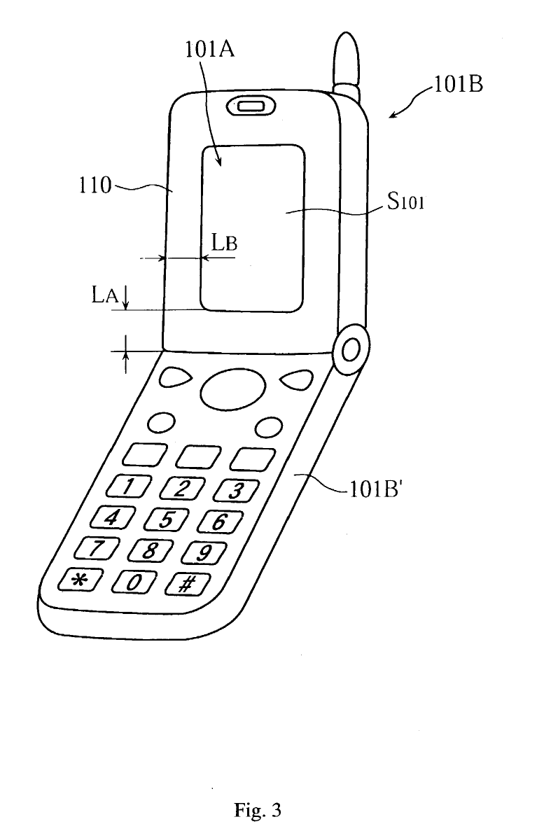

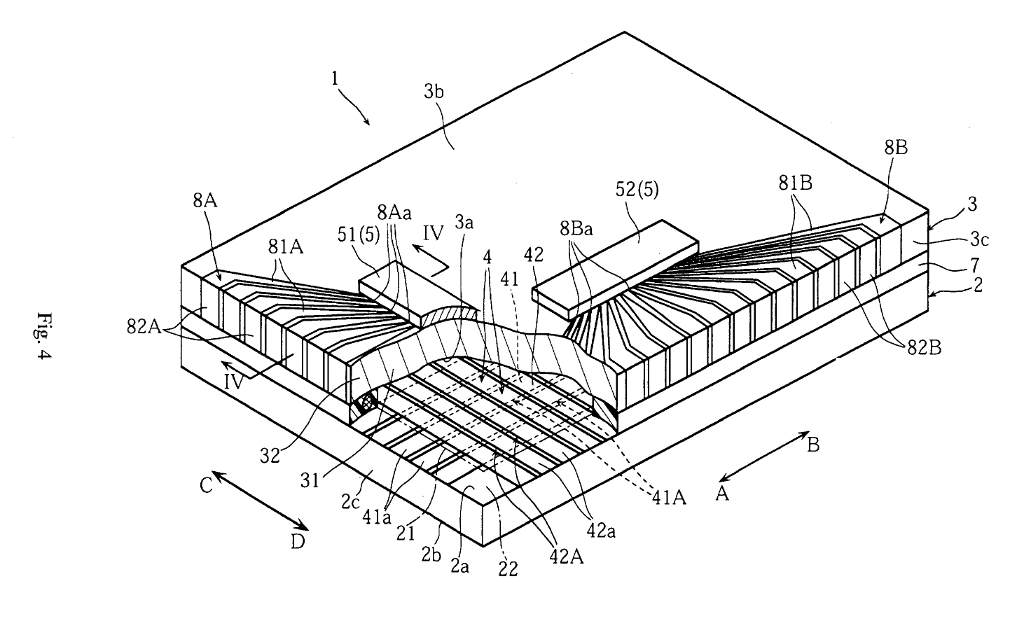

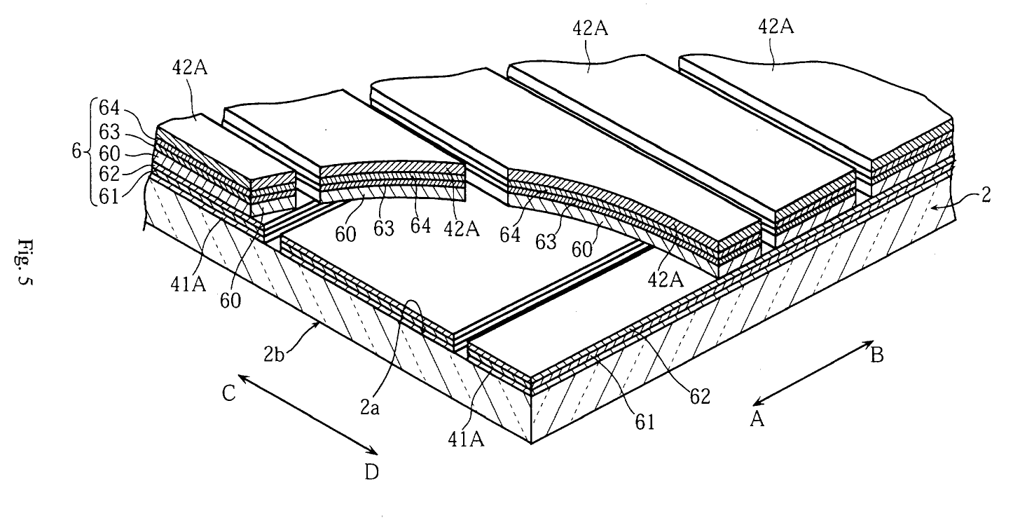

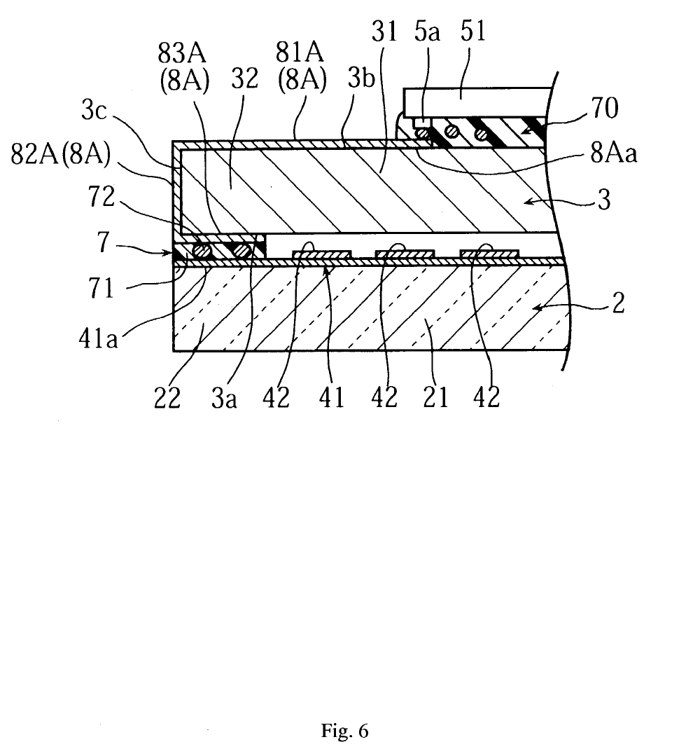

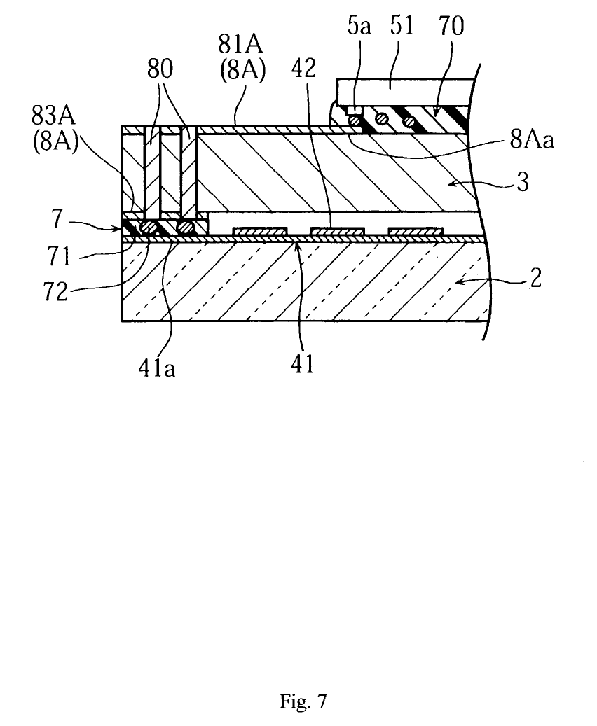

FIG. 4 is a schematic perspective drawing showing an organic EL display device as one example of a flat panel display according to the present invention. FIG. 5 is a schematic perspective drawing showing the internal structure of the organic EL display device of FIG. 4 in detail, and FIG. 6 is a cross-sectional drawing taken along the lines IV-IV of FIG. 4. Further, FIG. 7 is a schematic cross-sectional drawing showing another example of a flat panel display according to the present invention. Further, in these drawings, the same reference numbers and characters are used to indicate the same members and the same portions as those shown in FIGS. 1-3 which show a related art example.

As shown in FIG. 4, a display device 1 is equipped with a substrate 2 serving as a first plate-shaped member, a cover 3 serving as a second plate-shaped member in which at least one portion faces the substrate 2, a plurality of display elements 4 arranged in the shape of a matrix, and a drive IC 5 for driving the plurality of display elements 4. In the display device 1, the display elements 4 include a pair of electrode elements 41, 42 (i.e., a first electrode element 41 and a second electrode element 42), and an organic substance layer 6 (cf. FIG. 5) provided between the pair of electrode elements 41, 42, and the organic substance layer 6 is constructed to emit light by electroluminescence when a voltage is applied thereto using the pair of electrode elements 41, 42.

Further, in the present embodiment, the display device 1 is constructed so that each display element 4 is driven by passive driving according to a linear sequential method, and a plurality of strip-shaped anodes 41A and a plurality of strip-shaped cathodes 42A mutually orthogonal to each other are provided between the substrate 2 and the cover 3, and the intersecting regions thereof form the display elements 4. Further, the first and second electrode elements 41, 42 are portions corresponding to each display element 4 at each anode 41A and each cathode 42A.

The substrate 2 is a transparent substrate formed from a transparent glass or film made of resin, for example. The substrate 2 is formed to have a rectangular plate shape when the entire substrate 2 is viewed flat, and includes a facing surface (active surface) 2a which faces the cover 3, a non-facing surface (passive surface) 2b which is a surface opposite the facing surface 2a, and a plurality of end surfaces 2c which form a link between the facing surface 2a and the non-facing surface 2b. Further, the substrate 2 is formed from a display element arrangement portion 21 in which the display elements 4 are arranged, and a peripheral portion 22 arranged to surround the display element arrangement portion 21. The display element arrangement portion 21 is the portion forming the effective display region of the display device 1, and is provided in a center portion of the substrate 2. Further, the display element arrangement portion 21 has a rectangular shape when viewed flat. The peripheral portion 22 is provided in a manner that makes the width dimension thereof (i.e., the distance from the periphery of the display element arrangement portion 21 to the periphery of the substrate 2) relatively small.

The cover 3 is constructed as a protection member for preventing degradation of the display elements 4, and is formed from a material having insulating properties such as glass, ceramic, resin or the like, for example. The cover 3 is connected to the substrate 2 via a sealing member 7 (described in detail later), whereby a sealed state is created between the substrate 2 and the cover 3. The cover 3 is formed to have the same width as the substrate 2 when viewed flat, and the sealing member 7 is arranged between a peripheral portion 32 of the cover 3 and the peripheral portion 22 of the substrate 2. Further, in the present embodiment, the cover 3 has an overall plate shape, and includes a facing surface 3a which faces the substrate 2, a non-facing surface 3b opposite the facing surface 3a, and a plurality of end surfaces 3c which form a link between the facing surface 3a and the non-facing surface 3b.

Further, in the present embodiment, the cover 3 is formed to have an overall plate shape, and may be formed, for example, to have a shape in which the peripheral portion 32 thereof protrudes toward the substrate 2, namely, the cover 3 may be formed to have an overall box shape.

Each anode 41A is a transparent electrode, and is formed by carrying out an etching process or the like after vapor depositing an ITO (Indium Tin Oxide) film, for example. Each anode 41A is formed to extend in the direction of the arrows AB shown in FIG. 4 and FIG. 5, and the end portions thereof extend to the top of the peripheral portion 22 of the substrate 2 to form end portion electrode elements 41a.

Each cathode 42A is formed to extend in the direction of the arrows CD shown in FIG. 4 and FIG. 5 orthogonal to the anodes 41A, and the end portions thereof extend to the top of the peripheral portion 22 of the substrate 2 to form end portion electrode elements 42a. The cathodes 42A are formed by carrying out an etching process or the like after vapor depositing an aluminum film, for example.

As shown in FIG. 5, the organic substance layer 6 is formed from a plurality of hole filling layers 61, a plurality of hole transporting layers 62, a plurality of light emitting layers 60, a plurality of electron transporting layers 63, and a plurality of electron filling layers 64.

The hole filling layers 61 have a function of improving the efficiency of producing holes from the anodes 41A, namely, the hole filling efficiency of the organic substance layer 6. The hole transporting layers 62 move holes to the light emitting layer 60 with good efficiency, and inhibit the movement of electrons from the cathodes 42A across the light emitting layers 60 to the anodes 41A, whereby the hole transporting layers 62 have a function of increasing the recombination efficiency of the electrons and the holes in the light emitting layers 60.

The hole filling layers 61 and the hole transporting layers 62 are formed in the shape of strips which extend in the same direction as the anodes 41A (i.e., the direction of the arrows AB shown in FIG. 4 and FIG. 5). The hole filling layers 61 are laminated onto the anodes 41A, and the hole transporting layers 62 are laminated onto the hole filling layers 61.

Each of the light emitting layers 60 are formed in the shape of strips which extend in a direction (i.e., the direction of the arrows CD shown in FIG. 4 and FIG. 5) orthogonal to the extending direction of the anodes 41A (i.e., the direction of the arrows AB shown in FIG. 4 and FIG. 5). Each light emitting layer 60 includes a light emitting substance, and is the place where excitons are created by the recombination of the holes from the anodes 41A and the electrons from the cathodes 42A. The excitons move through the light emitting layers 60, and this process causes the light emitting substance to emit light.

The electron filling layers 64 have a function of improving the efficiency of producing electrons from each cathode 42A, namely, the electron filling efficiency of the organic substance layer 6. The electron transporting layers 63 move electrons to each light emitting layer 60 with good efficiency, and inhibit the movement of holes from each anode 41A across the light emitting layers 60 to the cathodes 42A, whereby the electron transporting layers 63 have a function of increasing the recombination efficiency of the electrons and the holes in the light emitting layers 60.

The electron transporting layers 63 and the electron filling layers 64 are formed in the shape of strips which extend in the same direction as the light emitting layers 60 (i.e., the direction of the arrows CD shown in FIG. 4 and FIG. 5). The electron transporting layers 63 are laminated onto the light emitting layers 60, and the electron filling layers 64 are laminated onto the electron filling layers 63.

The drive IC 5 controls the voltage applied to each anode 41A and each cathode 42A based on prescribed electric power and signals supplied or transmitted from the outside of the display device 1 via a flexible flat cable (FPC) or the like not shown in the drawings. As shown in FIG. 4, the two drive ICs 51, 52 form the drive IC 5 in the present embodiment. The drive IC 51 conducts electricity to the plurality of anodes 41A, and applies a sequential selected voltage to each anode 41A. On the other hand, the drive IC 52 conducts electricity to the plurality of cathodes 42A, and inputs signal voltages corresponding to the display elements 4 synchronized with clock pulses to each cathode 42A.

As shown in FIG. 4, in the display device 1, both the drive IC 51 and the drive IC 52 are mounted on top of the non-facing surface 3b of the cover 3, and are connected to each display element 4 via a plurality of wires 8A and a plurality of wires 8B described below.

Namely, as shown in FIG. 4, the number of wires 8A and the number of wires 8B are the same as the number of anodes 41A and the number of cathodes 42A, respectively, and the wires 8A, 8B are formed on the outside surface of the cover 3. As shown in FIG. 4 and FIG. 6, the wires 8A, 8B respectively include input terminal portions 8Aa, 8Ba for applying drive voltages via the drive ICs 51, 52, and these input terminal portions 8Aa, 8Ba are provided on the non-facing surface 3b of the cover 3. The wires 8A, 8B respectively include non-facing surface wire portions 81A, 81B, end surface wire portions 82A, 82B, and facing surface wire portions 83A, 83B. Further, the anodes 41A and the cathodes 42A are electrically connected to the facing surface wire portions 83A, 83B via the sealing member 7.

As is well understood from FIG. 6, the facing surface wire portion 83A (83B) is formed on the facing surface 3a of the cover 3, and is provided on the peripheral portion 32 thereof in the present embodiment. The facing surface wire portions 83A, 83B are arranged to face the end portion electrode elements 41a, 42a of the anodes 41A and the cathodes 42A, and electricity is conducted to the facing surface wire portions 83A, 83B by conductive particles 72 (described later) inside the sealing member 7.

The end surface wire portions 82A, 82B are formed on the end surface 3c of the cover 3. Further, the end surface wire portions 82A, 82B are formed over the entire thickness of the cover 3, and the bottom end portions thereof are connected to the facing surface wire portions 83A, 83B.

The non-facing surface wire portions 81A, 81B are formed on the non-facing surface 3b of the cover 3. Further, the non-facing surface wire portions 81A, 81B are formed to extend from the upper ends of the end surface wire portions 82A, 82B toward the drive ICs 51, 52, and the input terminal portions 8Aa, 8Ba are formed on the tips thereof. The drive ICs 51, 52 are mounted on top of the non-facing surface 3b of the cover 3 so that output terminals 5a thereof conduct electricity with the input terminal portions 8Aa, 8Ba by an anisotropic conductive resin 70 or the like.

The non-facing surface wire portions 81A, 81B, the end surface wire portions 82A, 82B and the facing surface wire portions 83A, 83B are formed, for example, by etching or the like after vapor depositing a thin metal film such as aluminum or the like on each surface.

As described above, the sealing member 7 is a member for connecting the cover 3 to the substrate 2, and is constructed from a portion which conducts electricity between the facing surface wire portions 83A, 83B and the end portion electrode elements 41a, 42a of the anodes 41A and the cathodes 42A which face each other, and other portions formed in an insulated state. The sealing member 7 is formed from a known anisotropic conductive resin, for example. The anisotropic conductive resin is a resin formed by dispersing and mixing conductive particles 72 inside an adhesive resin component 71 having insulating properties, wherein a thermosetting resin or an UV hardening resin or the like is used as the adhesive resin component, for example, and metal balls of gold or the like or resin balls in which the surface is coated with such metal or the like are used as the conductive particles 72.

The anisotropic conductive resin (sealing member 7) is applied between the peripheral portion 22 of the substrate 2 and the peripheral portion 32 of the cover 3, and then the adhesive resin component 71 is hardened by heat or UV irradiation, whereby the cover 3 is connected to the substrate 2. At this time, at the portion where the facing surface wire portions 83A, 83B face the end portion electrode elements 41a, 42a of the anodes 41A and the cathodes 42A, electricity is conducted between the facing surface wire portions 83A, 83B and the end portion electrode elements 41a, 42a of the anodes 41A and the cathodes 42A by the conductive particles 72 inside the anisotropic conductive resin 7 arranged therebetween. On the other hand, at the other portions, the conductive particles 72 make direct contact with the substrate 2 and the cover 3, and the insulating properties are maintained. In this way, by constructing the sealing member 7 from an anisotropic conductive resin, it is possible to easily conduct electricity between the facing surface wire portions 83A, 83B and the end portion electrode elements 41a, 42a of the anodes 41A and the cathodes 42A without carrying out a physical process between the peripheral portion 22 of the substrate 2 and the peripheral portion 32 of the cover 3.

In the display device 1 described above, in the case where a voltage greater than or equal to a prescribed value is applied between the anodes 41A and the cathodes 42A corresponding to selected display elements 4 by the drive IC 5, the hole filling layers 61 are filled with holes from the anodes 41A, and the electron filling layers 64 are filled with electrons from the cathodes 42A. The holes are transported to the light emitting layers 60 via the hole transporting layers 62, and the electrons are transported to the light emitting layers 60 via the electron transporting layers 63. In the light emitting layers 60, the electrons and the holes recombine and form excitons, and these excitons move through the light emitting layers 60. In the light emitting layers 60, light is emitted by the energy released when the excitons move between prescribed bands in the light emitting substance. The light at this time passes through the hole transporting layers 62, the hole filling layers 61 and the anodes 41A and the substrate 2, and is emitted to the outside of the display device 1. In this way, an image is displayed on the effective display region, namely, the non-facing surface 2b side of the display element arrangement portion 21 of the substrate 2 by the light emitted from the selected display elements 4.

In the display device 1 described above, the input terminals 8Aa, 8Ba are formed on the non-facing surface 3b of the cover 3, and in this way, the drive ICs 51, 52 are mounted to the non-facing surfaces 3b of the cover 3. Namely, in the display device 1, because the region where the drive ICs 51, 52 are mounted is not provided adjacent to the effective display region in the substrate as in the related art example, it is possible to increase the proportion of the display device 1 occupied by the effective display region when the display device 1 is viewed flat. As a result, in the case where the surface area of the display device 1 when the display device 1 is viewed flat is set at a prescribed value, the surface area of the effective display region can be made relatively large, and in the reverse case where the surface area of the effective display region is set at a prescribed value, the surface area of the display device 1 when the display device 1 is viewed flat can be made relatively small.

Further, in this kind of display device 1, because there is no need for the non-display region provided in the related art example, the elimination of such portion makes it possible to reduce the cost of materials.

As for the driving method, the display device 1 uses a passive driving method in which the display elements 4 are directly driven by a voltage applied between the anodes 41A and the cathodes 42A, but it is also possible to use an active driving method in which an active element such as a TFT or the like is provided. This is also true for display devices described in the embodiments given below.

In the wires 8A, 8B in the display device 1 described above, the non-facing surface wire portions 81A, 81B and the facing surface wire portions 83A, 83B are connected via the end surface wire portions 82A, 82B, but as shown in FIG. 7, it is also possible to construct the wires to include through holes 80 instead of the end surface wire portions 82A, 82B. These kind of through holes 80 are formed by forming through holes in the portion where the non-facing surface wire portions 81A, 81B and the facing surface wire portions 83A, 83B are formed in the cover 3, and then filling the inside of these through holes with metal or the like. Accordingly, in the case where the thickness of the cover 3 is relatively small, the operation for forming the through holes 80 becomes easier than the operation for forming the end surface wire portions 82A, 82B. Further, instead of conducting electricity between the non-facing surface wire portions 81A, 81B and the facing surface wire portions 83A, 83B by the end surface wire portions 82A, 82B or the through holes 80, it is also possible to conduct electricity therebetween by wires or the like using a wire bonding technique, for example.

In the display device 1 described above, the two drive ICs 51, 52 are provided to drive the display device 1, but it is also possible to control the voltage applied to each anode 41A and each cathode 42A by one drive IC, for example, or a plurality of drive ICs can be used to control each anode 41A or each cathode 42A, for example.

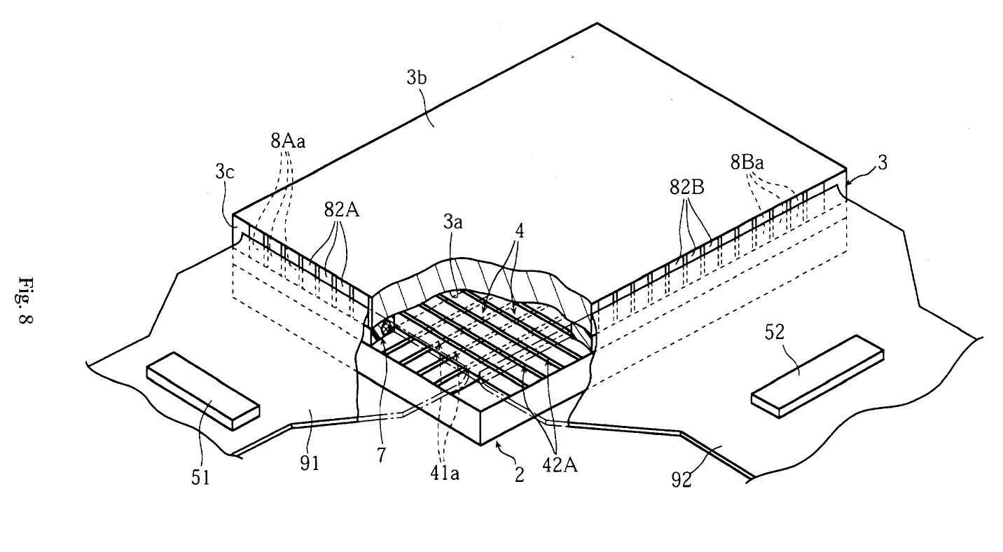

In the display device 1 described above, the drive ICs 51, 52 are directly mounted on top of the non-facing surface 3b of the cover 3, but as shown in FIG. 8, it is also possible to mount the drive ICs 51, 52 on top of FPCs 91, 92 connected to the cover 3. The FPCs 91, 92 can be mounted to the cover 3 on the non-facing surface 3b or the end surfaces 3c, and the latter case is shown in FIG. 8. In this case, there is no need to form the non-facing surface wire portions 81A, 81B on the wires 8A, 8B, but on the other hand, the input terminal portions 8Aa, 8Ba are formed on the end surface wire portions 82A, 82B as portions where the FPCs 91, 92 are formed in place of the drive ICs 51, 52.

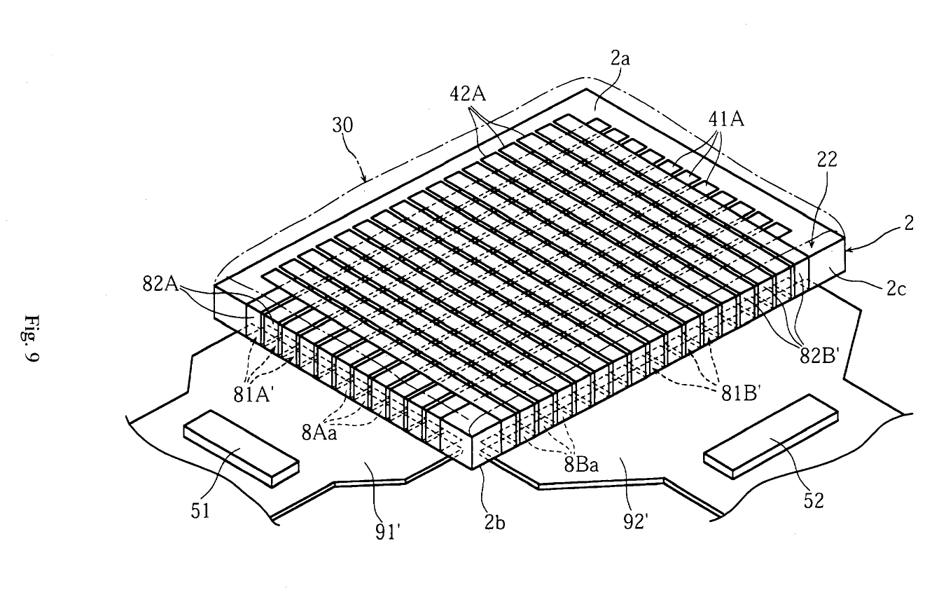

Further, as shown in FIG. 9, the drive ICs 51, 52 can also be mounted to FPCs 91′, 92′ connected to the substrate 2. Further, in the case where the width of the drive ICs 51, 52 is shorter than the width of the peripheral portion 22, the drive ICs 51, 52 can also be mounted to the peripheral portion 22 of the non-facing surface 2b of the substrate 2. Namely, the drive ICs 51, 52 can be mounted to the substrate 2 instead of the cover 3 either directly or indirectly via the FPCs 91′, 92′. In this case, the wires 8A, 8B are formed on the substrate 2. Specifically, in FIG. 9, end surface wire portions 82A′, 82B′ corresponding to the end surface wire portions 82A, 82B in the display device 1 described above are formed on the end surfaces 2c of the substrate 2 so as to be connected to the end portion electrode elements 41a, 42a of the anodes 41A and the cathodes 42A, and underside surface wire portions 81A′, 81B′ corresponding to the non-facing surface wire portions 81A, 81B in the display device 1 described above are formed on the peripheral portion 22 of the non-facing surface 2b of the substrate 2. The input terminal portions 8Aa, 8Ba (i.e., the portions corresponding thereto) are formed on the end surfaces 2c or the peripheral portion 22 of the non-facing surface 2b of the substrate 2. Further, in FIG. 9, a resin coating layer 30 is provided on the facing surface 2a of the substrate 2 as a member for preventing degradation of the display elements 4, and in this way, it is possible to omit the cover 3 and the sealing member 7.

Further, in the embodiment described above, the organic substance layer 6 is constructed from the hole filling layers 61, the hole transporting layers 62, the light emitting layers 60, the electron transporting layers 63 and the electron filling layers 64, but the present invention is not limited to this arrangement. This is also true for the embodiments given below.

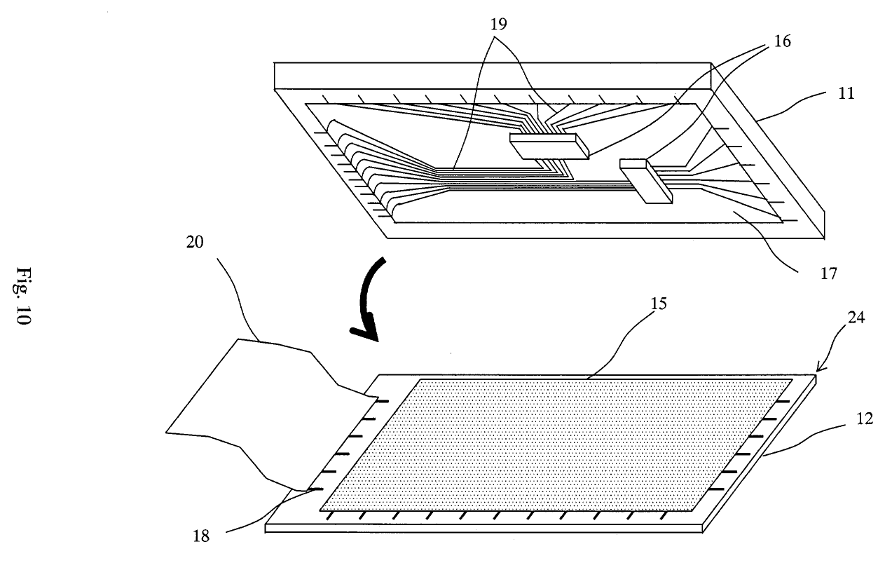

FIG. 10 is a schematic drawing of an organic EL display device as one example of a flat panel display according to another embodiment of the present invention. In FIG. 10, the number 11 represents a sealing plate made from ceramic or glass, and the number 12 represents a glass substrate serving as a transparent substrate. In this regard, the transparent substrate includes a glass substrate and substrates made from a transparent resin, a color filter or a color changing material and the like. A transparent electrode layer (not shown in the drawings), an organic EL layer (not shown in the drawings), and a metal electrode layer 15 are sequentially laminated onto the top surface of the glass substrate 12. The transparent electrode layer (not shown in the drawings) is formed from transparent electrodes made of ITO (Indium Tin Oxide), indium zinc oxide, tin oxide or the like in order to transmit the EL light emitted by the organic EL layer. The organic EL layer emits light by the EL phenomenon. The metal electrode layer 15 applies an electric field to the organic EL layer provided between the metal electrode layer 15 and the transparent electrode layer. In the metal electrode material, it is possible to use Al, Li, Mg or an alloy of these metals. The number 17 represents a sealing plate inside surface which is an inside surface of a concave portion provided in the sealing plate 11. The number 16 represents an electronic circuit which is mounted to the sealing plate inside surface 17. The electronic circuit 16 includes a drive circuit which supplies drive signals to the metal electrodes and the transparent electrodes of an organic EL element 24, and a supervisory control circuit of the organic EL element 24. Circuit elements such as chip resistors, chip capacitors and the like are arranged around the electronic circuit 16. The number 20 represents a flexible substrate which serves as outside wires which supply signals from the outside to the electronic circuit 16. The number 18 represents electrode terminals connected to the flexible substrate 20 which serves as outside wires. The electrode terminals 18 can be made from the same material as the transparent electrodes or the metal electrodes, or a different material. Preferably, the material should have low resistance and stability against outside air. The electrode terminals 18 can be connected to electrodes corresponding to the electrode terminals 18 or a bus line formed between the electrodes. The number 19 represents wires which form connections between the electrode terminals 18 and the electronic circuit 16, and connections between the electronic circuit 16 and the metal electrodes or the transparent electrodes. The organic EL element 24 is equipped with the glass substrate 12 and the transparent electrode layer, the organic EL layer and the metal electrode layer 15 laminated on the top surface of the substrate 12.

The sealing plate 11 seals the organic EL element 24 as indicated by the arrow shown in FIG. 10. As a result, signals from the flexible substrate 20 are inputted into the electronic circuit 16 via the electrode terminals 18 and the wires 19 arranged on one end of the glass substrate 12 of the organic EL element 24. The electronic circuit 16 drives the transparent electrodes and the metal electrodes of the organic EL element 24 via the wires 19, whereby light is emitted from the pixels at the intersections of both electrodes. The emitted light passes through the substrate 12 and is emitted to the outside. As a result, the organic display element can function as an image display or a light source.

As described above, because the electronic circuit mounted to the sealing plate inside surface of the organic EL display device is operated via the flexible substrate connected to one end of the organic EL element, except for one end of the organic EL display device, it is possible to reduce the so-called picture frame.

In this kind of arranged structure, the flexible substrate is connected to both facing ends of the organic EL display device, and when the electronic circuit mounted to the sealing plate inside surface is operated, except for both facing ends of the organic EL display device, it is possible to reduce the so-called picture frame.

Further, because the sealing plate 11 is bonded to the glass substrate 12 by an ultraviolet light hardening resin, when ultraviolet light is shone from the glass substrate side of the organic EL display device, there is a need for a mask to protect the organic EL layer. In this regard, if the sealing plate 11 is constructed by a transparent member, it is possible to shine ultraviolet light from the sealing plate 11 side, and because the metal electrode layer 15 functions as a mask, there is no need for a masking process, and this makes it possible to carry out mass production. As for the transparent material, it is possible to use transparent resin or glass.

In the next embodiment, a description will be given for a method of protecting the organic EL layer which is weakened by water.

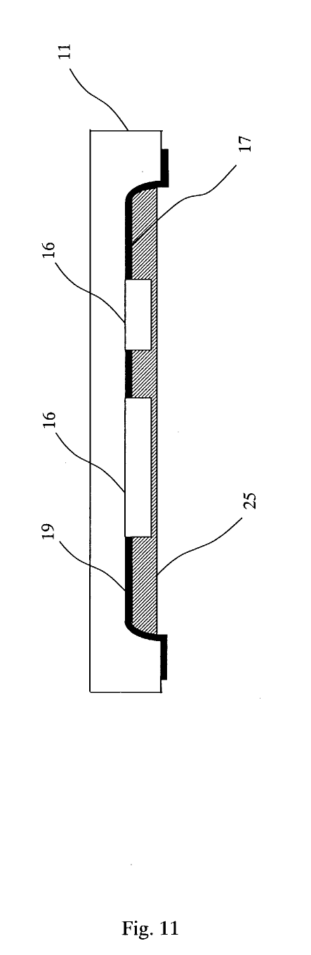

FIG. 11 is a cross-sectional drawing of a sealing plate of an organic EL display device according to another embodiment of the present invention. The number 11 represents a sealing plate, the number 16 represents an electronic circuit, the number 17 represents a sealing plate inside surface, the number 19 represents wires, and the number 25 represents a drying agent layer. The electronic circuit 16 includes a drive circuit which supplies drive signals to the metal electrodes and the transparent electrodes of an organic EL element 24, and a supervisory control circuit of the organic EL element 24. Circuit elements such as chip resistors, chip capacitors and the like are arranged around the electronic circuit 16.

The electronic circuit 16 is mounted to the sealing plate inside surface 17, and the wires 19 form connections between the electronic circuit 16 and electrode terminals connected to outside wires, and connections between the electronic circuit 16 and the metal electrodes or transparent electrodes. A dry agent layer 25 which includes a drying agent is laminated onto the top surface thereof. As for the drying agent, typically barium oxide or the like can be used. These drying agents are mixed in resin, and then as shown in FIG. 11, such resin is applied to the top surface of the electronic circuit 16. As shown in FIG. 11, the drying agent layer lamination can be carried out to cover the electronic circuit 16, or lamination can be carried out so that the electronic circuit 16 is not covered. When the electronic circuit 16 is not covered, the sealing plate 11 is not made thicker by the drying agent layer lamination. After the organic EL element is sealed by the sealing plate 11, the drying agent layer 25 absorbs water that penetrates in or water that is produced inside.

As described above, when the drying agent layer is laminated onto the sealing plate inside surface, it is possible to protect the organic EL layer without changing the thin structure of the organic EL display device.

Next, a description will be given for a method of connecting the wires inside the sealing plate to the electrodes or electrode terminals of the organic EL element in the present embodiment.

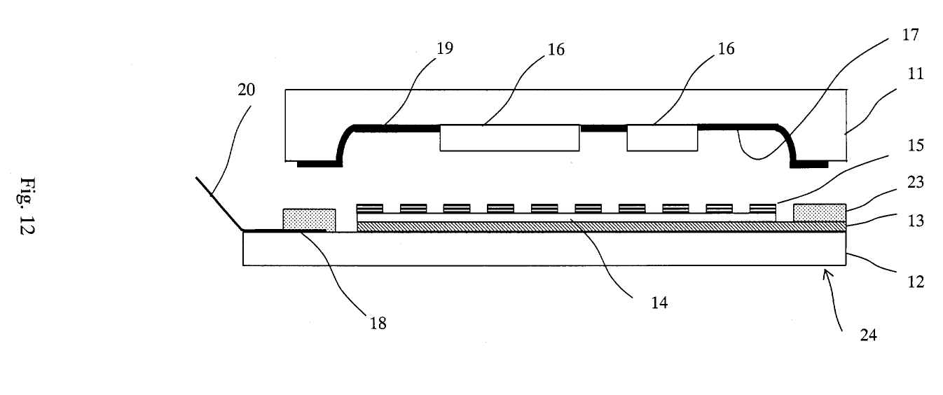

FIG. 12 is a cross-sectional drawing of the organic EL display device according to the present embodiment. The number 11 represents a sealing plate made from ceramic or glass, and the number 12 represents a glass substrate serving as a transparent substrate. In this regard, the transparent substrate includes a glass substrate and substrates made from a transparent resin, a color filter or a color changing material and the like. A transparent electrode layer 13, an organic EL layer 14, and a metal electrode layer 15 are sequentially laminated onto the top surface of the glass substrate 12. The transparent electrode layer 13 is formed from transparent electrodes made of ITO (Indium Tin Oxide), indium zinc oxide, tin oxide or the like in order to transmit the EL light emitted by the organic EL layer, and extends to the outside of the organic EL layer 14 on the top surface of the glass substrate 12 in order to form a connection with a drive circuit. The organic EL layer 14 emits light by the EL phenomenon. The metal electrode layer 15 applies an electric field to the organic EL layer 14 provided between the metal electrode layer 15 and the transparent electrode layer 13. In the metal electrode material, it is possible to use Al, Li, Mg or an alloy of these metals. The metal electrode layer 15 also extends (in the vertical direction in the drawings) to the outside of the organic EL layer 14 on the top surface of the glass substrate 12 in order to form a connection with a drive circuit. The number 17 represents a sealing plate inside surface which is an inside surface of a concave portion provided in the sealing plate 11. The number 16 represents an electronic circuit which is mounted to the sealing plate inside surface 17, and includes a function which supplies drive signals to the metal electrodes and the transparent electrodes of an organic EL element 24, and carries out supervisory control of the organic EL element 24. Circuit elements such as chip resistors, chip capacitors and the like are arranged around the electronic circuit 16. The number 20 represents a flexible substrate which serves as outside wires which connect the electronic circuit 16 to the outside. The number 18 represents electrode terminals connected to the flexible substrate 20 which serves as outside wires. The number 19 represents wires which form connections between the electrode terminals 18 and the electronic circuit 16, and connections between the electronic circuit 16 and the metal electrodes or the transparent electrodes. The organic EL element 24 is equipped with the glass substrate 12 and the transparent electrode layer, the organic EL layer and the metal electrode layer 15 laminated on the top surface of the substrate 12.

A seal 23 is used when sealing the organic EL element 24 by the sealing plate 11. The seal 23 is bonded to the periphery of the glass substrate 12 of the organic EL element 24. The transparent electrode layer 13 and the metal electrode layer 15 also extend to the periphery of the glass substrate 12, and the electrode terminals 18 are also arranged on the periphery of the substrate 12. The seal 23 is also bonded to the top surfaces of these elements. When the sealing plate 11 is crimped to the organic EL element 24, bonding is carried out by this seal. Further, conductive particles are also mixed in the seal 23. Accordingly, by carrying out crimping, the conductive particles conduct electricity between outside wires corresponding to the sealing plate 11 and the transparent electrode layer 13, the metal electrode layer 15 and the electrode terminals 18 provided on the periphery of the glass substrate 12. By conducting electricity, the electronic circuit 16 becomes connected to the outside and the transparent electrodes or the metal electrodes.

In this way, by mixing conductive particles in the seal 23, at the same time the organic EL element 24 and the sealing plate 11 are bonded together, it is possible to easily connect the drive circuit on the sealing plate inside surface with the electrode terminals 18 on top of the organic EL element 24, the metal electrodes of the metal electrode layer 15, and the transparent electrodes of the transparent electrode layer 13. By carrying out this kind of connection method, it is possible to minimize the space where the electrode terminals are arranged, and because there is no need for a special location to connect the transparent electrodes or the metal electrodes to the electronic circuit on the sealing plate inside surface, it is possible to reduce the so-called picture frame of the organic EL display device.

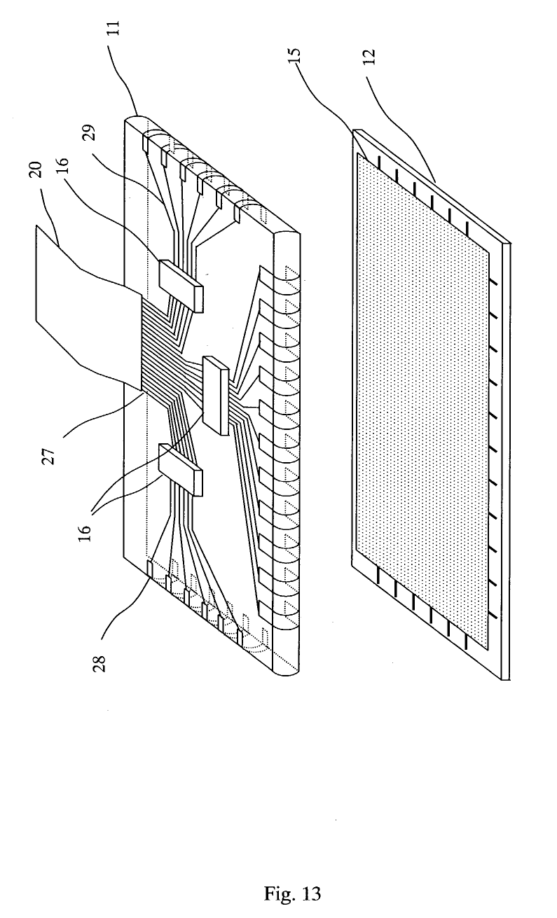

FIG. 13 is a schematic drawing of an organic EL display device according to another embodiment of the present invention. In FIG. 13, the number 11 represents a sealing plate made from crystallized glass, and the number 12 represents a glass substrate serving as a transparent substrate. In this regard, the transparent substrate includes a glass substrate, a transparent resin substrate, and substrates made from a color filter or a color changing material and the like. A transparent electrode layer (not shown in the drawings), an organic EL layer (not shown in the drawings), and a metal electrode layer 15 are sequentially laminated onto the top surface of the glass substrate 12. The organic EL element is equipped with the glass substrate 12 and the transparent electrode layer (not shown in the drawings), the organic EL layer (not shown in the drawings) and the metal electrode layer 15 laminated on the top surface of the substrate 12. The transparent electrode material includes ITO (Indium Tin Oxide), indium zinc oxide, tin oxide or the like. In the metal electrode material, it is possible to use Al, Li, Mg or an alloy of these metals. The number 16 represents an electronic circuit which includes a drive circuit which drives the organic EL element, and a supervisory control circuit of the organic EL element. Circuit elements such as chip resistors, chip capacitors and the like are arranged around the electronic circuit 16. The number 27 represents electrode terminals provided on the outside surface of the sealing plate 11 to form connections with outside wires, and the number 28 represents electrode terminals provided on the outside surface of the sealing plate 11 to transfer the wires formed on the outside surface of the sealing plate 11 to the inside surface of the sealing plate 11. The electrode terminals can be made from the same material as the electrodes, or a different material. Preferably, the material should have low resistance and stability against outside air. The electrode terminals can be connected to electrodes corresponding to the electrode terminals or a bus line formed between the electrodes. The number 29 represents thick film wires which form connections between the electronic circuit 16 and the electrode terminals 27, 28 mounted to the outside surface of the sealing plate 11. The number 20 represents a flexible substrate which serves as outside wires which enable signals to be sent and received between the electronic circuit 16 and the outside.

As described above, a sealing plate needs to be provided in the organic EL display device in order to protect the organic display device from water, and in order to avoid heating, an ultraviolet light hardening resin is used to bond the sealing plate to the glass substrate of the organic EL element. At the time the sealing plate is bonded to the glass substrate of the organic EL element by the ultraviolet light hardening resin, a mask which protects the organic EL layer from ultraviolet light is needed when ultraviolet light is shone from the glass substrate side of the organic EL display device. In this regard, if the sealing plate is constructed by a transparent member, it is possible to shine ultraviolet light from the sealing plate side, and because the metal electrode layer 15 functions as a mask of the organic EL layer, there is no need for a masking process, and this makes it possible to shine ultraviolet light on mass-produced organic EL display devices. As for the transparent member of the sealing plate, it is possible to apply transparent resin or various kinds of glass.

On the other hand, in order to reduce the so-called picture frame portion of the organic EL display device, the electronic circuit and electrode terminals which form connections with outside wires need to be provided on the sealing plate, and for this reason, the wires that form connections with these elements must be formed on the outside surface of the sealing plate. The heat resistance temperature required for the sealing plate varies depending on the method of forming the wires. The methods of forming the wires are roughly classified as a thin film wiring method which combines a thin film spatter method and a photolithography method, and a thick film wiring method in which wires are formed by screen printing or a transfer method using a paste such as an organic gold, silver palladium or the like. The thin film wiring method makes it possible to form wires at a relatively low temperature, but because this method is complex, the manufacturing cost is increased. In the thick film wiring method, after the wires are formed, because the organic binder and the like contained in the wires need to be vaporized by high temperature sintering, the sealing plate needs to have heat resistance against a temperature of about 900° C., but the process is simple and the manufacturing cost can be reduced. For these reasons, the thick film wiring method which makes it possible to reduce the manufacturing cost is preferred. Accordingly, the sealing plate must be a member having a heat resistance that at least makes it possible to form wires by the thick film wiring method. 5 In this regard, the transparent resin on which the electronic circuit is mounted and the circuit wires are formed has the problem of low heat resistance. Further, the softening point of float glass is lower than 900° C. which is the temperature for forming thick film wires. Glasses which have a softening point higher than 900° C. include crystallized glass and quartz glass. However, quartz glass is expensive and difficult to form. On the other hand, crystallized glass also has a softening point higher than 900° C., but up to now, crystallized glass has been opaque to ultraviolet light. In this regard, the present inventor measured the transmittance of crystallized glass, and discovered that crystallized glass is opaque to ultraviolet light at the thickness used in kitchen utensils, but was able to confirm that crystallized glass has sufficient transparency at the thickness used for the sealing plate of the organic EL display device. Further, crystallized glass can easily be formed into any desired shape by a pressing process before crystallization. Accordingly, crystallized glass was selected for application to the sealing plate.

The crystallized glass used in the sealing plate has a transparency that at least makes it possible to harden ultraviolet light hardening resin with ultraviolet light having a wavelength of 300 nm, and because ultraviolet light can be shone from the sealing plate side without a mask, this arrangement is suited to mass production. Further, because the sealing plate also has heat resistance to the high temperature at which the organic binder is vaporized, it is possible to apply the simple thick film wiring method to the manufacturing process. As a result, in the present embodiment, crystallized glass is used in the sealing plate.

As shown in FIG. 13, the electronic circuit 16, the electrode terminals 27 which connect to the flexible substrate 20, and the electrode terminals 28 which transfer the wires formed on the outside surface of the sealing plate 11 to the inside of the sealing plate 11 are arranged on the outside surface of the sealing plate 11 made of crystallized glass, and connections between these elements are formed by the thick film wires 29. In order to connect the wires on the outside surface of the sealing plate 11 to the inside surface, the electrode terminals 28 are formed by transfer paper printing, and drive signals from the electronic circuit 16 are transmitted to the transparent electrode layer (not shown in the drawings) and the metal electrode layer 15 laminated on the top surface of the glass substrate 12. The electrode terminals 28 can also connect the wires on the outside surface of the sealing plate 11 to the inside by through holes bored in the sealing plate 11. In this way, because the electronic circuit is mounted to the outside surface of the sealing plate of the organic EL display device, and outside wires are connected to the electrode terminals on the outside surface of the sealing plate, there is practically no need for the so-called picture frame of the organic EL display device.

In the present organic EL display device, the electronic circuit 16 is operated via the flexible substrate 20, and the electronic circuit 16 drives the transparent electrodes and the metal electrodes of the organic EL element, whereby light is emitted from the pixels at the intersections of both electrodes. This emitted light passes through the glass substrate 12 and is emitted to the outside. As a result, the organic display element can function as an image display or a light source.

As described above, when crystallized glass is used in the sealing plate of the organic EL display device, it is possible to harden the ultraviolet light hardening resin by ultraviolet light shone from the sealing plate side, and this manufacturing method is suited to mass production. Further, because the electronic circuit is mounted to the outside surface of the sealing plate, and outside wires are connected to the electrode terminals of the outside surface of the sealing plate, it is possible to reduce the so-called picture frame of the organic EL display device.

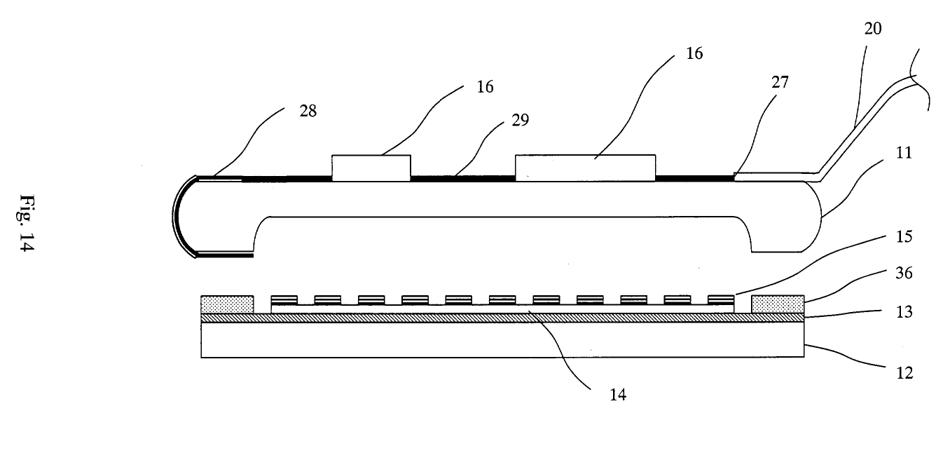

Next, a description will be given for a method of covering the glass substrate 12 by the sealing plate 11 made of crystallized glass on which the electronic circuit and the like are mounted. FIG. 14 is a cross-sectional drawing of the sealing plate 11 and the glass substrate 12 before covering. In FIG. 14, the number 11 represents a sealing plate, the number 12 represents a glass substrate, the number 13 represents a transparent electrode layer, the number 14 represents an organic EL layer, the number 15 represents a metal electrode layer, the number 16 represents an electronic circuit, the number 29 represents thick film wires, and the number 36 represents ultraviolet light hardening resin. An organic EL element is formed by sequentially laminating the transparent electrode layer 13, the organic EL layer 14 and the metal electrode layer 15 onto the top of the glass substrate 12. Then, the ultraviolet light hardening resin 36 is applied to a peripheral portion of the glass substrate 12 of the organic EL element. Next, the electronic circuit 16 is mounted in advance, and then the organic EL element is covered by the sealing plate 11 on which connections between the electrode terminals 17, 28 and the electronic circuit 16 are formed by the thick film wires 29.

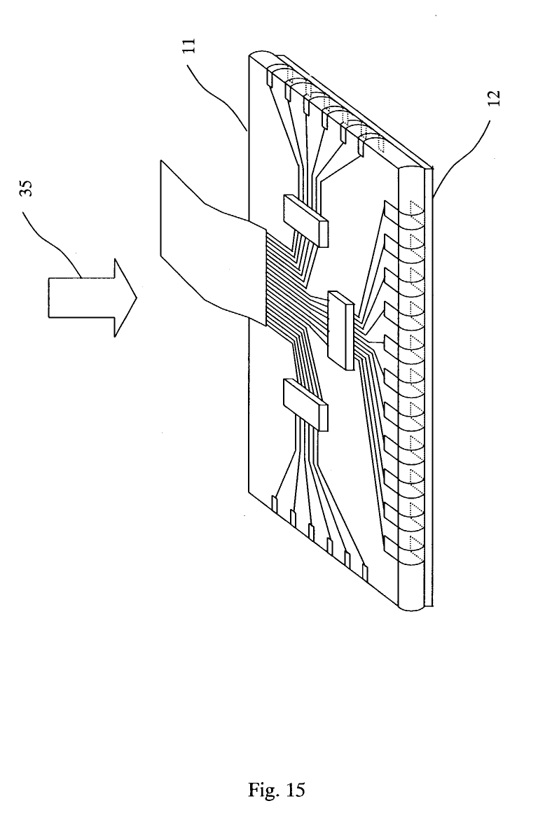

FIG. 15 shows the organic EL element covered by the sealing plate 11. As shown in FIG. 15, ultraviolet light 35 is shone from the sealing plate 11 side to harden the ultraviolet light hardening resin 36. When the ultraviolet light 35 is shone, because the metal electrode layer 15 forms a mask which protects the organic EL layer 14, it is possible to shine ultraviolet light only one time on mass-produced organic EL display devices.

As described above, because the thick film wires and the like are formed in advance on the sealing plate, the organic EL layer is not exposed to high temperatures. Further, when ultraviolet light is shone from the transparent sealing plate side, because there is no need to provide a separate mask for blocking ultraviolet light, this method of hardening bonding agents with ultraviolet light can be suitably applied to mass production.

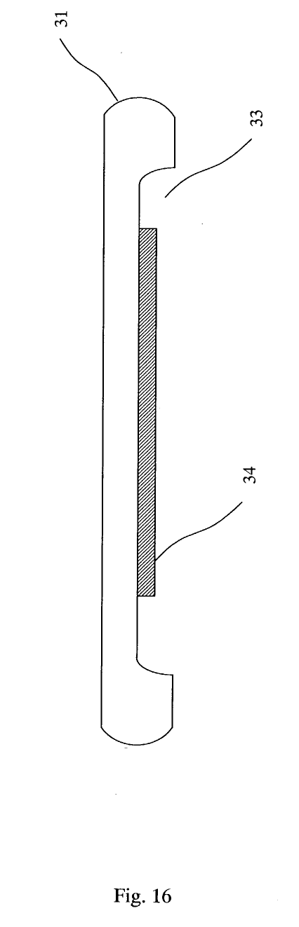

Because the organic EL layer is weakened by water, the inside of the organic EL display device needs to be kept dry. Generally, a moisture absorbing material such as barium oxide or the like is provided inside the organic display element. A cross-sectional view of the sealing plate used in the present embodiment is shown in FIG. 16. In FIG. 16, the number 31 represents a sealing plate made by crystallized glass, the number 34 represents a moisture absorbing agent, and the number 33 represents a housing concave portion of the sealing plate 31.

As shown in FIG. 16, the concave portion 33 is provided in the inside surface of the sealing plate 31. When the sealing plate 31 is bonded to the organic EL element, it is possible to protect the organic EL display device from water by providing the moisture absorbing agent 34 in the concave portion 33. Because crystallized glass can be easily formed into any desired shape by a pressing process before crystallization, the concave portion 33 can be easily provided. Accordingly, the sealing plate shown in FIG. 13 or FIG. 15 is formed to have the shape of the sealing plate 31 shown in FIG. 16, the electronic circuit is mounted to the outside surface of the sealing plate 31, and after the thick film wires are formed, the moisture absorbing agent 34 is housed in the concave portion 33 of the sealing plate 31, and then the sealing plate 31 is bonded to the glass substrate 12.

As described above, when crystallized glass is used in the sealing plate, it is possible to easily form a concave portion for housing a moisture absorbing agent, and the moisture absorbing agent makes it possible to protect the organic EL display device from water.

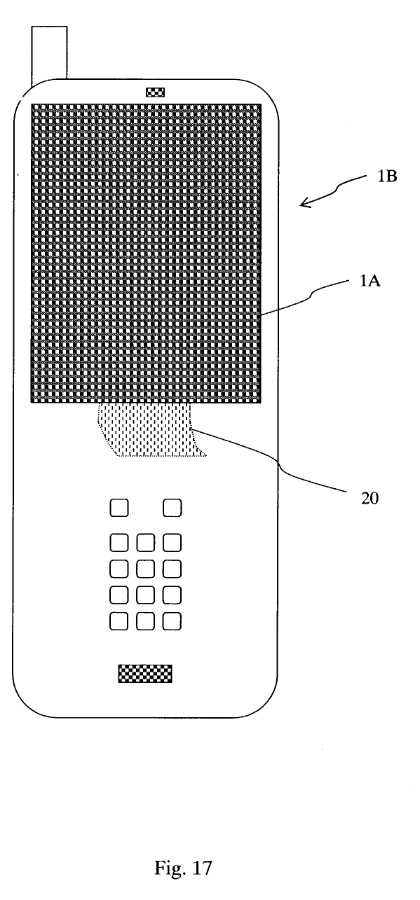

When any of one the organic EL display devices described in the embodiments up to this point is combined with a portable terminal having a display portion, it is possible to increase the size of the display portion with respect to the body of the portable terminal. An outside view of a portable terminal equipped with one of the organic EL display devices described above is shown in FIG. 17. In FIG. 17, the reference 1B represents a portable terminal, the reference 1A represents a display portion, and the number 20 represents a flexible substrate. The flexible substrate 20 is an internal structure of the portable terminal 1B, and can not be seen from the outside.

As shown in FIG. 17, the organic EL display device makes it possible to reduce the so-called picture frame, and because the flexible substrate is connected to the sealing plate without using a so-called picture frame, it is possible to increase the size of the display portion 1A in the left, right, top and bottom directions of the body of the portable terminal. In particular, when the electrode terminals are arranged only in one of the four directions of the organic EL display device, the display portion can occupy the upper part of a portable telephone, as shown in FIG. 17.

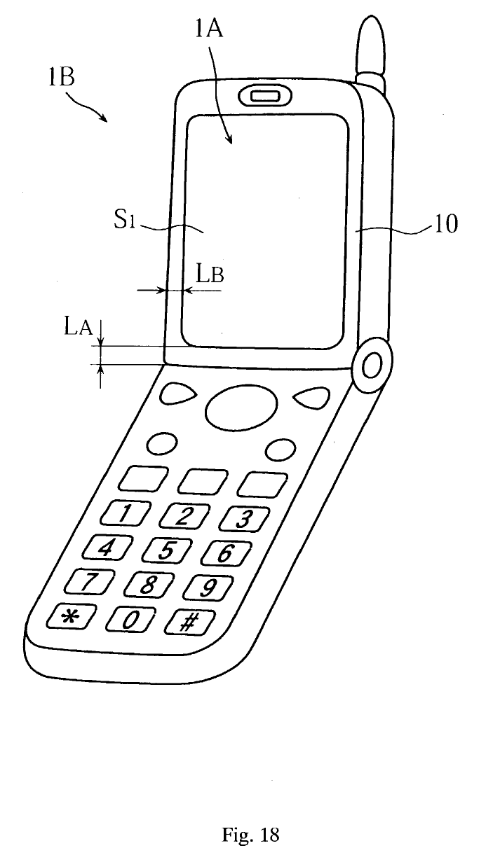

FIG. 18 is a schematic perspective drawing showing a portable telephone as one example of a portable terminal according to the present invention. A portable telephone 1B shown in FIG. 18 includes information display means 1A for displaying specific information. The portable telephone 1B is equipped with one of the above-described organic EL display devices (hereafter referred to simply as “display device”) as the information display means 1A. In the portable telephone 1B equipped with this kind of display device, because the proportion of the display device occupied by the effective display region is large, and because the widths L_{A}, L_{B} of a frame portion 10 provided around a display screen S₁ (i.e., the effective display region of the display device) shown in FIG. 18 do not need to be made large, it is possible to make the display screen S₁ relatively wide even when the terminal body is miniaturized.

Of course, the present invention is not limited to the embodiments described above, and it is possible to make various changes without departing from the scope of the invention as defined by the appended claims.

For example, in the embodiments described above, the portable terminal equipped with the information display means 1A is the portable telephone 1B, but such portable terminal can also be a PDA or the like, for example, or some other portable terminal. Further, the information display means 1A is an organic EL display device, but such display means can also be a liquid crystal display device, a LED display device, an inorganic EL display device or the like, or some other display device.

What is claimed is:

1. A flat panel display, comprising:
a first plate-shaped member;
a second plate-shaped member having at least one portion facing the first plate-shaped member;
a plurality of display elements arranged in the shape of a matrix and including a pair of electrode elements;
a drive IC for driving the plurality of display elements; and
a plurality of wires which connect the drive IC to the display elements and which include an input terminal portion for applying a drive voltage to the display elements via the drive IC;
wherein the first plate-shaped member and the second plate-shaped member have facing surfaces which face each other, non-facing surfaces which are opposite the facing surfaces, and a plurality of end surfaces which form a link between the facing surfaces and the non-facing surfaces; and
wherein the input terminal portion is provided on one of the non-facing surfaces or one of the end surfaces.

2. The flat panel display of claim 1, wherein the input terminal portion is provided on at least one of the non-facing surfaces of the first and second plate-shaped members, and the drive IC is mounted to one of the non-facing surfaces of the first and second plate-shaped members.

3. The flat panel display of claim 1, wherein the first plate-shaped member and the second plate-shaped member are bonded together via a sealing member, each wire includes a facing surface wire portion provided on the facing surface of the first plate-shaped member or second plate-shaped member on which the input terminal portion is formed, and at least one of the pair of electrode elements is electrically connected to the facing surface wire portions via the sealing member.

4. The flat panel display of claim 3, wherein the sealing member is constructed from an anisotropic conductive resin.

5. The flat panel display of claim 3, wherein each wire further includes a non-facing surface wire portion which includes the input terminal portion provided on the non-facing surface of the first plate-shaped member or second plate-shaped member on which the input terminal portion is formed, and an end surface wire portion formed on one of the end surfaces of the first plate-shaped member or second plate-shaped member on which the input terminal portion is formed in order to form a connection between the non-facing surface wire portion and the facing surface wire portion.

6. The flat panel display of claim 3, wherein each wire further includes a non-facing surface wire portion which includes the input terminal portion provided on the facing surface of the first plate-shaped member or second plate-shaped member on which the input terminal portion is formed, and through holes which form a connection between the non-facing surface wire portion and the facing surface wire portion.

7. The flat panel display of claim 1, wherein the display elements include an organic substance layer provided between the pair of electrode elements, wherein the organic substance layer is constructed to emit light by electroluminescence when a voltage is applied thereto using the pair of electrode elements.

8. A portable terminal, comprising:
information display means for displaying specific information;
wherein the flat panel display of claim 1 is used as the information display means.

9. A flat panel display, comprising:
a substrate;
a plurality of display elements arranged in the shape of a matrix and including a pair of electrode elements;
a drive IC for driving the plurality of display elements; and
a plurality of wires which connect the drive IC to the display elements and which include an input terminal portion for applying a drive voltage to the display elements via the drive IC;
wherein the substrate includes an active surface on which the plurality of display elements are arranged, a passive surface opposite the active surface, and a plurality of end surfaces which form a link between the active surface and the passive surface; and
wherein the input terminal portion is provided on the passive surface or one of the end surfaces.

10. The flat panel display of claim 9, wherein the display elements include an organic substance layer provided between the pair of electrode elements, and the organic substance layer is constructed to emit light by electroluminescence when a voltage is applied thereto using the pair of electrode elements.

11. A portable terminal, comprising:
information display means for displaying specific information;
wherein the flat panel display of claim 9 is used as the information display means.

12. A flat panel display, comprising:
a transparent substrate;
a light emitting element which includes a plurality of display elements arranged in the shape of a matrix on top of the transparent substrate;
a sealing plate which covers the light emitting element;
an electronic circuit mounted to an inside surface of the sealing plate to operate the light emitting element;
a plurality of electrode terminals arranged on the periphery of the light emitting element to form connections with outside wires; and
a plurality of wires formed on the inside surface of the sealing plate to form connections between the light emitting element and the electronic circuit, and connections between the electrode terminals and the electronic circuit.

13. The flat panel display of claim 12, wherein a drying agent layer is laminated onto the inside surface of the sealing plate.

14. The flat panel display of claim 12, wherein the sealing plate is bonded to the light emitting element by a seal which includes anisotropic conductive particles, whereby the electronic circuit is electrically connected to the display elements and the electrode elements.

15. The flat panel display of claim 12, wherein the electrode terminals are arranged only in one of the four directions of the light emitting element.

16. The flat panel display of claim 12, wherein the display elements include a transparent electrode layer, an organic electroluminescence layer and a metal electrode layer sequentially laminated onto the top of the transparent substrate.

17. A portable terminal, comprising:
information display means for displaying specific information;
wherein the flat panel display of claim 12 is used as the information display means.

18. A flat panel display, comprising:
a transparent substrate;
a light emitting element having a plurality of display elements arranged in the shape of a matrix on top of the transparent substrate;
a sealing plate made from crystallized glass which covers the light emitting element;
an electronic circuit mounted to an outside surface of the sealing plate;
a plurality of electrode terminals provided on the outside surface of the sealing plate; and
a plurality of thick film wires which form connections between the electronic circuit and the electrode terminals.

19. The flat panel display of claim 18, wherein the sealing plate is bonded to the light emitting element by an ultraviolet light hardening resin.

20. The flat panel display of claim 18, further comprising a moisture absorbing agent housed in a concave portion formed in an inside surface of the sealing plate.

21. The flat panel display of claim 18, wherein the display elements include a transparent electrode layer, an organic electroluminescence layer and a metal electrode layer sequentially laminated onto the top of the transparent substrate.

22. A portable terminal, comprising:
information display means for displaying specific information;
wherein the flat panel display of claim 18 is used as the information display means.

23. A method of manufacturing a flat panel display, comprising the steps of:
bonding a sealing plate made of crystallized glass to a light emitting element having a plurality of display elements arranged in the shape of a matrix on top of a transparent substrate;
mounting an electronic circuit to an outside surface of the sealing plate in advance;
forming thick film wires on the outside surface of the sealing plate in advance;
applying an ultraviolet light hardening resin between the sealing plate and an organic EL element; and
hardening the ultraviolet light hardening resin by ultraviolet light shone from the sealing plate side.

24. The method of manufacturing a flat panel display of claim 23, wherein the display elements include a transparent electrode layer, an organic electroluminescence layer and a metal electrode layer sequentially laminated onto the top of the transparent substrate.

25. A portable terminal, comprising:
information display means for displaying specific information;
wherein a flat panel display manufactured by the method of manufacturing a flat panel display of claim 23 is used as the information display means.
